(19) United States
(12) Patent Application Publication
(10) Pub. No.: US 2025/0243922 A1
(43) Pub. Date: Jul. 31, 2025

(54) PNEUMATIC VIBRATION ISOLATION SYSTEM USING A SINGLE-DIRECTIONAL FLOW RESTRICTION VALVE

(71) Applicant: 10x Genomics, Inc., Pleasanton, CA (US)

(72) Inventor: Vu Huy Nguyen, Livermore, CA (US)

(21) Appl. No.: 19/042,764

(22) Filed: Jan. 31, 2025

Related U.S. Application Data
(60) Provisional application No. 63/627,415, filed on Jan. 31, 2024.

(51) Int. Cl. F16F 15/023; F16F 15/00; F16F 15/027

(52) U.S. Cl. CPC F16F 15/0232; F16F 15/002; F16F 15/0275; F16F 2222/126; F16F 2228/066

(57) ABSTRACT

Provided herein are assemblies, systems, and methods for increasing the effective stiffness and/or damping of a pneumatic vibration isolation system. In various embodiments, a system includes a payload to be isolated from vibrations, a source of pressurized gas, a plurality of pneumatic vibration damping modules coupled to the payload, and a one-way restrictor valve fluidically coupled between the source of pressurized gas and the plurality of vibration damping modules. Each pneumatic vibration damping module of the plurality of pneumatic vibration damping modules is fluidically coupled to the source of pressurized gas.

### CROSS-REFERENCE TO RELATED APPLICATIONS

This application claims the benefit of priority to U.S. Provisional App. No. 63/627,415, filed on Jan. 31, 2024. The entire contents of which are hereby incorporated by reference.

### FIELD

The present disclosure is directed to improving pneumatic vibration isolator performance. In particular, pneumatic vibration isolator performance (e.g., settling time of an isolated payload) can be improved by increasing the effective stiffness of the air spring and/or increasing the dampening of the air damper.

### BACKGROUND

Analytical instruments (e.g., an opto-fluidic instrument) used for imaging a biological sample generally require high precision motion systems configured to move optical (e.g., an objective lens) and/or mechanical (e.g., a stage) subsystems to allow for imaging microscopic fluorescence puncta emitted from target analytes (e.g., RNA transcripts, DNA, protein, etc.) within the biological sample. For example, optical and mechanical subsystems of an opto-fluidic instrument may perform volumetric imaging (e.g., z-stack imaging) of multiple fields-of-view of the biological sample with sub-micron z-steps between image slices. Vibrational disturbances of the analytical instrument due to internal or external factors may cause significant performance issues, such as incorrect localization of fluorescent puncta, higher error rates, lower quality scores, longer run times due to repeated imaging cycles, and/or a complete failure of an experiment resulting in monetary loss. Existing methods of reducing vibrational disturbances to analytical instruments include positioning the analytical instrument on an isolated tabletop of a vibration isolation system. Various forms of vibration isolation systems include passive (e.g., pneumatic) or active (e.g., inertial feedback, feedforward, PZT-based, etc.). However, active systems are generally not suitable for isolating larger payloads.

While passive vibration isolation systems can effectively reduce vibrations on isolated payloads (which includes the tabletop and the analytical instrument), the effectiveness of the vibration isolation system is limited at least by the size of the isolated payload, and more specifically, the location of the center of gravity of the isolated payload. Many analytical instruments tend to be large in size, and therefore have a high center of gravity, which may cause the isolated payload to become unstable and reduce the effectiveness of vibration isolation. Unstable payloads may take significantly longer to settle after a vibrational disturbance or may not settle enough to suitably perform imaging of the biological sample. Accordingly, systems and methods are needed for improving the settling time of an isolated payload on a passive vibration isolation system.

### SUMMARY

Disclosed herein is a system including a payload to be isolated from vibrations, a source of pressurized gas, and a plurality of pneumatic vibration damping modules coupled to the payload. Each pneumatic vibration damping module of the plurality of pneumatic vibration damping modules is fluidically coupled to the source of pressurized gas. The system further includes a one-way restrictor valve fluidically coupled between the source of pressurized gas and the plurality of vibration damping modules.

In various embodiments, the system further includes a tube fluidically coupling the source of pressurized gas to the plurality of pneumatic vibration dampening modules.

In various embodiments, at least two pneumatic vibration damping modules of the plurality of pneumatic vibration damping modules are fluidically coupled in parallel to the source of pressurized gas.

In various embodiments, all pneumatic vibration damping modules of the plurality of pneumatic vibration damping modules is fluidically coupled in parallel to the source of pressurized gas.

In various embodiments, the source of pressurized gas comprises air.

In various embodiments, the one-way restrictor valve is configured to allow pressurized gas to flow towards the plurality of vibration damping modules.

In various embodiments, the payload includes a substantially flat top surface.

In various embodiments, each pneumatic vibration damping module of the plurality of pneumatic vibration damping modules includes a piston disposed on a first chamber. In various embodiments, each pneumatic vibration damping module of the plurality of pneumatic vibration damping modules includes a second chamber adjacent to the first chamber. In various embodiments, the first chamber and second chamber are fluidically coupled via an orifice. In various embodiments, the orifice includes a valve and/or a capillary tube.

In various embodiments, the payload includes a tabletop and an optofluidic instrument positioned on the tabletop. In various embodiments, the one-way restrictor valve is configured to restrict flow of pressurized gas towards the source of pressurized gas. In various embodiments, the one-way restrictor valve is configured to increase an effective stiffness of the plurality of pneumatic vibration damping modules. In various embodiments, the one-way restrictor valve is configured to increase an effective damping of the plurality of pneumatic vibration damping modules. In various embodiments, the one-way restrictor valve is configured to reduce pressure oscillations in the system after an external force is applied to the payload.

Additionally disclosed herein is an assembly including a plurality of pneumatic vibration damping modules. Each pneumatic vibration damping module of the plurality of pneumatic vibration damping modules is configured to receive a pressurized gas. The assembly further includes a one-way restrictor valve and a tube fluidically coupling the one-way restrictor valve to the plurality of pneumatic vibration damping modules.

In various embodiments, at least two pneumatic vibration damping modules of the plurality of pneumatic vibration damping modules are fluidically coupled in parallel via the tube.

In various embodiments, all of the pneumatic vibration damping modules of the plurality of pneumatic vibration damping modules are fluidically coupled in parallel via the tube.

In various embodiments, the one-way restrictor valve is configured to allow pressurized gas to flow towards the plurality of vibration damping modules.

In various embodiments, each pneumatic vibration damping modules of the plurality of pneumatic vibration damping modules comprises a piston disposed on a first chamber.

In various embodiments, each pneumatic vibration damping module includes a second chamber adjacent to the first chamber, and the first chamber and second chamber are fluidically coupled via an orifice. In various embodiments, the orifice includes a valve and/or a capillary tube.

In various embodiments, the assembly further includes a payload coupled to the plurality of pneumatic vibration isolation modules. In various embodiments, the payload includes a tabletop and an optofluidic instrument positioned on the tabletop.

In various embodiments, the one-way restrictor valve is configured to restrict flow of pressurized gas towards the source of pressurized gas. In various embodiments, the one-way restrictor valve is configured to increase an effective stiffness of the plurality of pneumatic vibration damping modules. In various embodiments, the one-way restrictor valve is configured to increase an effective damping of the plurality of pneumatic vibration damping modules. In various embodiments, the one-way restrictor valve is configured to reduce pressure oscillations in the system after an external force is applied to the payload.

Additionally disclosed herein is a method of providing vibration isolation to a payload. The method includes providing a system including a payload, a source of pressurized gas, and a plurality of pneumatic vibration damping modules coupled to the payload. Each pneumatic vibration damping module of the plurality of pneumatic vibration damping modules is fluidically coupled to the source of pressurized gas. The system further includes a one-way restrictor valve fluidically coupled between the source of pressurized gas and the plurality of vibration damping modules. The method further includes providing, from the source of pressurized gas, a flow of pressurized gas through the one-way restrictor valve and to the plurality of pneumatic vibration damping modules thereby isolating the payload from vibrations.

Additionally disclosed herein is a system including a payload, a source of pressurized gas, means for vibrationally isolating the payload fluidically coupled to the source of pressurized gas, and a one-way restrictor valve fluidically coupled between the source of pressurized gas and the means for vibrationally isolating the payload.

Additionally disclosed herein is an assembly including means for vibrationally isolating a payload. The means for vibrationally isolating the payload is configured to receive a pressurized gas. The assembly further includes a one-way restrictor valve and a tube fluidically coupling the one-way restrictor valve to the means for vibrationally isolating the payload.

### BRIEF DESCRIPTION OF THE DRAWINGS

FIG. 1 is an example workflow of image data acquisition from a biological sample (e.g., a cell or tissue sample) using an opto-fluidic instrument, according to various embodiments.

FIGS. 2A-2B illustrate cross-sectional views of an optics module in an imaging system, according to some embodiments.

FIG. 3A illustrates an idealized, one degree-of-freedom isolator based on a simple harmonic oscillator. FIG. 3B illustrates a transmissibility curve of a harmonic oscillator. FIG. 3C illustrates a transfer function. FIG. 3D illustrates a time-domain response of a payload corresponding to the curves shown in FIG. 3C. FIGS. 3E-3F illustrate exemplary piston air isolators, according to some embodiments.

FIG. 4 illustrates a block diagram of a pneumatic vibration isolation system, according to some embodiments.

FIG. 5 illustrates a graph of damped and overdamped responses of an oscillator, according to some embodiments.

FIGS. 6A-6B illustrate zones of gravitational stability of an isolated payload supported on a tabletop, according to some embodiments.

FIG. 7A illustrates a cross-section of an opto-fluidic instrument, according to some embodiments. FIG. 7B illustrates a tilt test to determine a center of gravity of the opto-fluidic instrument shown in FIG. 7A, according to some embodiments.

FIG. 8A illustrates a graph of the center of gravity of an opto-fluidic instrument supported on an air isolation tabletop without a counterweight attached to the tabletop, according to some embodiments. FIG. 8B illustrates a graph of the center of gravity of an opto-fluidic instrument supported on an air isolation tabletop with a counterweight attached to the tabletop, according to some embodiments.

FIG. 9A illustrates an exemplary one-way flow restrictor valve, according to some embodiments. FIG. 9B illustrates a diagram of the one-way flow restrictor valve of FIG. 9A, according to some embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

As explained above, existing vibration isolation systems are insufficient for effectively isolating some larger payloads, such as analytical instruments having a high center of gravity, when the vibration isolation tabletop is small and light compared with the size and weight of the analytical instrument. Moreover, existing vibration isolation systems have long settling times or, at worst, are unstable and do not settle to a suitable value when larger payloads are positioned thereon. Thus, there exists a need to allow a smaller vibration isolation tabletop capable of handling larger and high center-of-gravity loads.

The present disclosure resolves the above technical problems by providing assemblies, systems, and methods to improve pneumatic vibration isolator performance. In particular, pneumatic vibration isolator performance (e.g., settling time of an isolated payload) can be improved by increasing the effective stiffness of the air spring and/or increasing the dampening of the air damper. One method to improve stability of the tabletop is to add a commercially available counterweight to the bottom of the tabletop, thereby lowering the CG into a more stable zone. However, using a counterweight does not solve all performance issues because adding more weight adds additional mass on each individual pneumatic isolators. Also, a counterweight may require one or more supporting members that add undesirable structural resonances into the dynamics of the vibration isolation table. In fact, stability issues may persist even after affixing a counterweight to the tabletop such that the center of gravity is within the gravitationally stable zone.

Passive pneumatic vibration isolation systems provide a cost-effective way for protecting sensitive instruments from external disturbances (e.g., vibrations). Moreover, automatic leveling systems adjust the pressure in the individual isolator modules to float the payload to an accurately controlled height and also adjust the stiffness of the isolators to provide a consistent isolation performance defined by the resonant frequency of the isolator, given by V (k/m). In this equation, k is the isolator's spring constant and m is the supported mass. In various embodiments, isolation starts at about 1.2-1.5 times the resonant frequency and may be dependent on damping. Below this resonant frequency, the isolators may amplify external disturbances (e.g., ground motion). Passive damping can reduce this amplification but at the cost of high-frequency isolation. A typical compromise between these two considerations is to limit the damping to a Quality factor of about 10.

As will be explained in more detail below, a newly discovered method of increasing pneumatic vibration isolator performance involves reducing (e.g., eliminating) pressure oscillations in the gas pressure of the system that are caused as a pneumatic isolator damps vibrations received from an external disturbance. Moreover, the newly discovered method of increasing pneumatic vibration isolator performance involves increasing the effective stiffness of the air spring and/or the effective damping of the air damper. These improvements can be achieved by including a single-directional flow restrictor that partially, or fully, restricts the gas flow in the reverse direction from the vibration isolation system back to the supplied air source.

### I. Overview

Target molecules (e.g., nucleic acids, proteins, antibodies, etc.) can be detected in biological samples (e.g., one or more cells or a tissue sample) using an instrument having integrated optics and fluidics modules (an “opto-fluidic instrument”). In an opto-fluidic instrument, the fluidics module is configured to deliver one or more reagents (e.g., fluorescent probes) to the biological sample and/or remove spent reagents therefrom. Additionally, the optics module is configured to illuminate the biological sample with light having one or more spectral emission curves (over a range of wavelengths) and subsequently capture one or more images of emitted light signals from the biological sample during one or more probing cycles. In various embodiments, the captured images may be processed in real time and/or at a later time to determine the presence of the one or more target molecules in the biological sample, as well as three-dimensional position information associated with each detected target molecule. Additionally, the opto-fluidics instrument includes a sample module configured to receive (and, optionally, secure) one or more biological samples. In some instances, the sample module includes an X-Y stage configured to move the biological sample along an X-Y plane (e.g., perpendicular to an objective lens of the optics module).

In various embodiments, the opto-fluidic instrument is configured to analyze one or more target molecules in their naturally occurring place (i.e., in situ) within the biological sample. For example, an opto-fluidic instrument may be an in-situ analysis system used to analyze a biological sample and detect target molecules including but not limited to DNA, RNA, proteins, antibodies, etc.

A sample disclosed herein can be or be derived from any biological sample. Biological samples may be obtained from any suitable source using any of a variety of techniques including, but not limited to, biopsy, surgery, and laser capture microscopy (LCM), and generally includes cells, tissues, and/or other biological material from the subject. A biological sample can be obtained from a prokaryote such as a bacterium, an archaea, a virus, or a viroid. A biological sample can also be obtained from eukaryotic mammalian and eukaryotic non-mammalian organisms (e.g., a plant, a fungus, an insect, an arachnid, a nematoda, a reptile, or an amphibian). A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic subjects, subjects that have or are suspected of having a disease (e.g., an individual with a disease such as cancer) or a pre-disposition to a disease, and/or subjects in need of therapy or suspected of needing therapy.

The biological sample can include any number of macromolecules, for example, cellular macromolecules and organelles (e.g., mitochondria and nuclei). The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions.

In some embodiments, the biological sample may comprise cells or a tissue sample which are deposited on a substrate. As described herein, a substrate can be any support that is insoluble in aqueous liquid and allows for positioning of biological samples, analytes, features, and/or reagents on the support. In some embodiments, a biological sample is attached to a substrate. In some embodiments, the substrate is optically transparent to facilitate analysis on the opto-fluidic instruments disclosed herein. For example, in some instances, the substrate is a glass substrate (e.g., a microscopy slide, cover slip, or other glass substrate). Attachment of the biological sample can be irreversible or reversible, depending upon the nature of the sample and subsequent steps in the analytical method. In certain embodiments, the sample can be attached to the substrate reversibly by applying a suitable polymer coating to the substrate and contacting the sample to the polymer coating. The sample can then be detached from the substrate, e.g., using an organic solvent that at least partially dissolves the polymer coating. Hydrogels are examples of polymers that are suitable for this purpose. In some embodiments, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

It is to be noted that, although the above discussion relates to an opto-fluidic instrument that can be used for in situ target molecule detection via probe hybridization, the discussion herein equally applies to any opto-fluidic instrument that employs any imaging or target molecule detection technique. That is, for example, an opto-fluidic instrument may include a fluidics module that includes fluids used for establishing the experimental conditions used for the probing of target molecules in the sample. Further, such an opto-fluidic instrument may also include a sample module configured to receive the sample, and an optics module including an imaging system for illuminating (e.g., exciting one or more fluorescent probes within the sample) and/or imaging light signals received from the probed sample. The in-situ analysis system may also include other ancillary modules configured to facilitate the operation of the opto-fluidic instrument, such as, but not limited to, cooling systems, motion calibration systems, etc.

### II. Exemplary Descriptions of Terms

As used herein the specification, “a” or “an” may mean one or more. As used herein in the claim(s), when used in conjunction with the word “comprising,” the words “a” or “an” may mean one or more than one. Some embodiments of the disclosure may consist of or consist essentially of one or more elements, method steps, and/or methods of the disclosure. It is contemplated that any method or composition described herein can be implemented with respect to any other method or composition described herein and that different embodiments may be combined.

The use of the term “or” in the claims is used to mean “and/or” unless explicitly indicated to refer to alternatives only or the alternatives are mutually exclusive, although the disclosure supports a definition that refers to only alternatives and “and/or.” For example, “x, y, and/or z” can refer to “x” alone, “y” alone, “z” alone, “x, y, and z,” “(x and y) or z,” “x or (y and z),” or “x or y or z.” It is specifically contemplated that x, y, or z may be specifically excluded from an embodiment. As used herein “another” may mean at least a second or more.

The term “ones” means more than one.

As used herein, the term “plurality” may be 2, 3, 4, 5, 6, 7, 8, 9, 10, or more.

As used herein, the term “set of” means one or more. For example, a set of items includes one or more items.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

As used herein, the term “about” refers to include the usual error range for the respective value readily known. Reference to “about” a value or parameter herein includes (and describes) embodiments that are directed to that value or parameter per se. For example, description referring to “about X” includes description of “X”. In some embodiments, “about” may refer to ±15%, ±10%, ±5%, or ±1% as understood by a person of skill in the art.

While the present teachings are described in conjunction with various embodiments, it is not intended that the present teachings be limited to such various embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

Throughout this specification, unless the context requires otherwise, the words “comprise”, “comprises” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

Reference throughout this specification to “one embodiment,” “an embodiment,” “a particular embodiment,” “a related embodiment,” “a certain embodiment,” “an additional embodiment,” or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in various embodiments.

### III. Opto-Fluidic Instruments for Analysis of Biological Samples

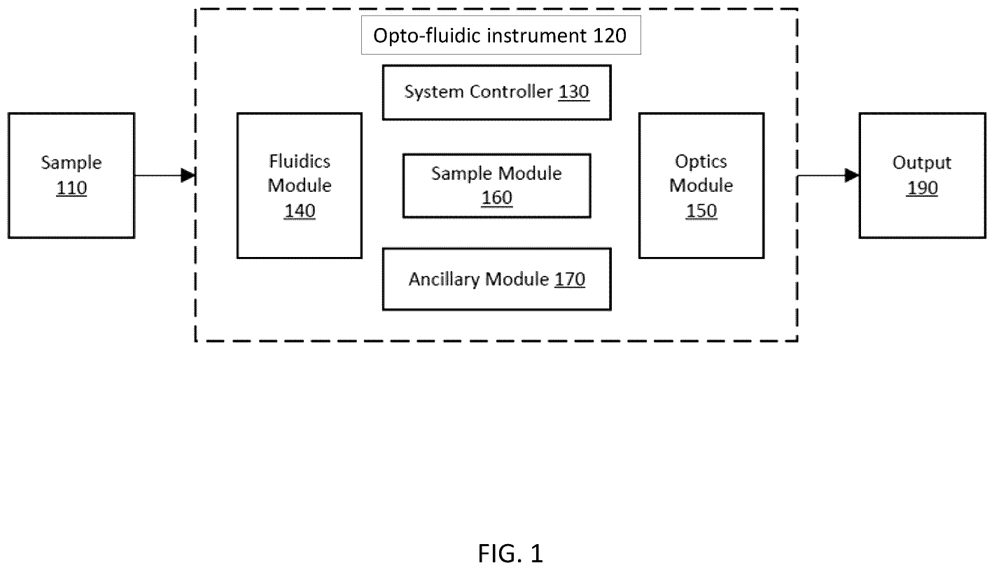

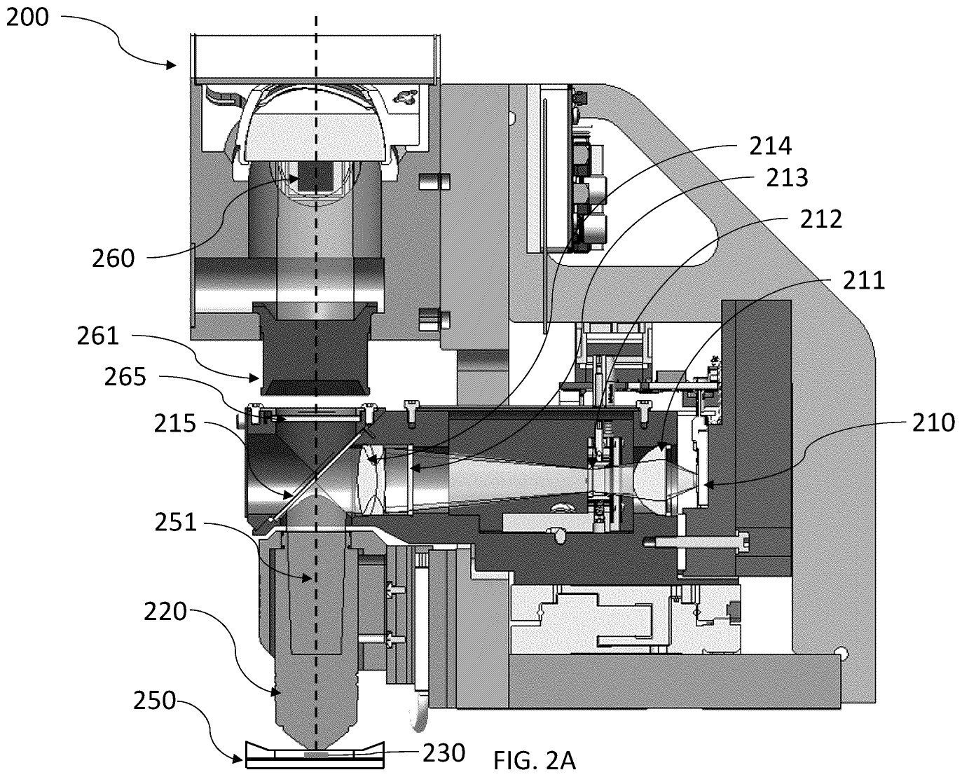

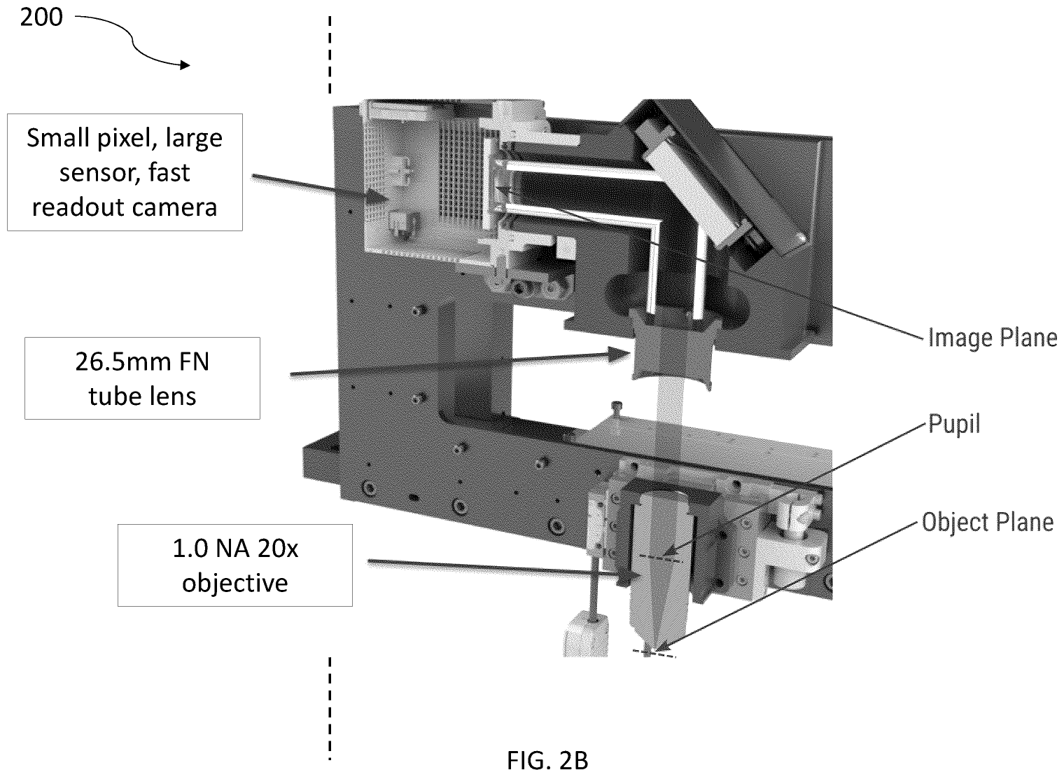

FIG. 1 illustrates a schematic diagram of an opto-fluidic instrument 120 configured for imaging of biological specimens, in accordance with various embodiments. As illustrated in FIG. 1, the opto-fluidic instrument 120 is configured for analyzing a sample 110 to generate an output 190.

In various embodiments, the sample 110 can be a biological sample (e.g., a tissue) that includes molecules targeted for analysis (i.e., target molecules), such as DNA, RNA, proteins, antibodies, etc. In various embodiments, the biological sample is a fresh frozen tissue. In various embodiments, the biological sample is a formalin-fixed paraffin-embedded (FFPE) sample. For example, the sample 110 can be a sectioned tissue that is treated to access the RNA thereof for labeling with circularizable DNA probes. In various embodiments, ligation of the probes generates a circular DNA probe which can be enzymatically amplified and bound with fluorescent oligonucleotides to produce a sufficiently bright signal that facilitates image acquisition and has a high signal-to-noise ratio.

In various embodiments, the sample 110 may be placed in the opto-fluidic instrument 120 for analysis and detection of the target molecules in the sample 110. In various embodiments, the opto-fluidic instrument 120 can be a system configured to facilitate the experimental conditions conducive for the detection of the molecules. For example, the opto-fluidic instrument 120 can include a fluidics module 140, an optics module 150, a sample module 160, and at least one ancillary module 170, and these modules may be operated by a system controller 130 to create the experimental conditions for the probing of the target molecules in the sample 110 by selected probes (e.g., circularizable DNA probes), as well as to facilitate the imaging of the probed sample (e.g., by an imaging system of the optics module 150). In various embodiments, the various modules of the opto-fluidic instrument 120 may be separate components. In various embodiments, the various modules of the opto-fluid instrument may be in electrical communication with each other. In various embodiments, at least some of the modules of the opto-fluidic instrument 120 may be integrated together into a single module.

In various embodiments, the sample module 160 may be configured to receive the sample 110 in the opto-fluidic instrument 120. For instance, the sample module 160 may include a sample interface module (SIM) that is configured to receive a sample device (e.g., cassette) in which a substrate (having the sample 110 positioned thereon) can be secured. In various embodiments, the substrate is a glass slide. That is, the sample 110 may be placed in the opto-fluidic instrument 120 by securing the substrate having the sample 110 (e.g., the sectioned tissue) within the sample device that is then inserted into the SIM of the sample module 160. In various embodiments, the SIM includes an alignment mechanism configured to secure the sample device within the SIM and align the sample device in X, Y, and Z axes within the SIM. In some instances, the sample module 160 may also include an X-Y stage onto which the SIM is mounted. The X-Y stage may be configured to move the SIM mounted thereon (e.g., and as such the sample device containing the sample 110 inserted therein) in perpendicular directions along a two-dimensional (2D) plane of the opto-fluidic instrument 120. Additional discussion related to the SIM can be found in Applicant's U.S. application Ser. No. 18/328,200, filed Jun. 2, 2023, titled “Methods, Systems, and Devices for Sample Interface,” which is incorporated herein by reference in its entirety.

The experimental conditions that are conducive for the detection of the target molecules in the sample 110 may depend on the target molecule detection technique that is employed by the opto-fluidic instrument 120. For example, in various embodiments, the opto-fluidic instrument 120 can be a system that is configured to detect molecules in the sample 110 via sequencing by hybridization (SBH) technique. In such cases, the experimental conditions can be molecule hybridization conditions that result in the intensity of hybridization of the target molecule (e.g., nucleic acid) to a probe (e.g., oligonucleotide) being significantly higher when the probe sequence is perfectly complementary to the target molecule than when there is a single-base mismatch. The hybridization conditions include the preparation of the sample 110 using reagents such as washing/stripping reagents, hybridizing reagents, etc., and such reagents may be provided by the fluidics module 140.

In various embodiments, the fluidics module 140 may include one or more components that may be used for storing the reagents, as well as for transporting said reagents to and from the sample device containing the sample 110. For example, the fluidics module 140 may include one or more reservoirs configured to store the reagents, as well as a waste container configured for collecting the reagents (e.g., and other waste) after use by the opto-fluidic instrument 120 to analyze and detect the molecules of the sample 110. In various embodiments, the one or more reservoirs include one or more high use reagent reservoirs. In various embodiments, the fluidics module 140 may be configured to receive one or more low use reagent plates (e.g., a 96 deep well plate). Further, the fluidics module 140 may also include pumps, tubes, pipettes, etc., that are configured to facilitate the transport of the one or more reagents (such non-limiting examples may include high use reagent and/or low use reagent) to the sample device and thus contact the sample 110 with the reagent (such non-limiting examples may include high use reagent and/or low use reagent). For instance, the fluidics module 140 may include one or more pumps (“reagent pumps”) that are configured to pump washing and/or stripping reagents (i.e., high use reagents) to the sample device for use in washing and/or stripping the sample 110. In various embodiments, the fluidics module 140 may be configured for other washing functions such as washing an objective lens of the imaging system of the optics module 150.

In various embodiments, the ancillary module 170 includes a cooling system (i.e., a heat transfer system) of the opto-fluidic instrument 120. In various embodiments, the cooling system includes a network of coolant-carrying tubes configured to transport coolant to various modules of the opto-fluidic instrument 120 for regulating the temperatures thereof. In such cases, the ancillary module 170 may include one or more heat transfer components of a heat transfer circuit. In various embodiments, the heat transfer components include one or more coolant reservoirs for storing coolants and pumps (e.g., “coolant pumps”) for generating a pressure differential, thereby forcing the coolants to flow from the reservoirs to the various modules of the opto-fluidic instrument 120 via the coolant-carrying tubes. In some instances, the heat transfer components of the ancillary module 170 may include returning coolant reservoirs that may be configured to receive and store returning coolants, i.e., heated coolants flowing back into the returning coolant reservoirs after absorbing heat discharged by the various modules of the opto-fluidic instrument 120. In such cases, the ancillary module 170 may also include one or more cooling fans that are configured to force air (e.g., cool and/or ambient air) to the external surfaces of the returning coolant reservoirs to thereby cool the heated coolant(s) stored therein. In some instance, the ancillary module 170 may also include one or more cooling fans that are configured to force air directly to one or more components of the opto-fluidic instrument 120 so as to cool said one or more components. For one non-limiting example, the ancillary module 170 may include cooling fans that are configured to directly cool by forcing ambient air past the system controller 130 to thereby cool the system controller 130.

As discussed above, the opto-fluidic instrument 120 may include an optics module 150 which include the various optical components of the opto-fluidic instrument 120, such as but not limited to a camera, an illumination module (such non-limiting examples may include one or more LEDs and/or one or more lasers), an objective lens, and/or the like. The optics module 150 may be a fluorescence imaging system that is configured to image the fluorescence emitted by the probes (e.g., oligonucleotides) in the sample 110 after the probes are excited by light from the illumination module of the optics module 150. In some instances, the optics module 150 may also include an optical frame onto which the camera, the illumination module, and/or the X-Y stage of the sample module 160 may be mounted.

In various embodiments, the system controller 130 may be configured to control the operations of the opto-fluidic instrument 120 (e.g., and the operations of one or more modules thereof). In some instances, the system controller 130 may take various forms, including a processor, a single computer (or computer system), or multiple computers in communication with each other. In various embodiments, the system controller 130 may be communicatively coupled with data storage, set of input devices, display system, or a combination thereof. In some cases, some or all of these components may be considered to be part of or otherwise integrated with the system controller 130, may be separate components in communication with each other, or may be integrated together. In other examples, the system controller 130 can be, or may be in communication with, a cloud computing platform.

In various embodiments, the opto-fluidic instrument 120 is configured to analyze the sample 110 and generate the output 190 that includes indications of the presence of the target molecules in the sample 110. For instance, with respect to the example embodiment discussed above where the opto-fluidic instrument 120 employs the SBH technique for detecting molecules, the opto-fluidic instrument 120 may cause the sample 110 to undergo successive rounds of fluorescent probe hybridization and be imaged to detect target molecules in the probed sample 110. In such cases, the output 190 may include optical signatures specific to each gene, which allow the identification of the target molecules.

### IV. Systems for Improved Pneumatic Vibration Isolation of a Payload

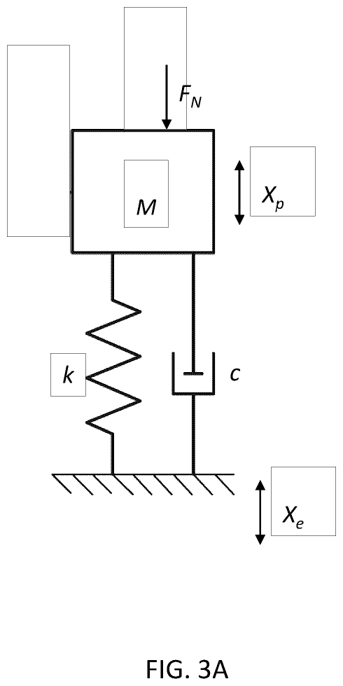

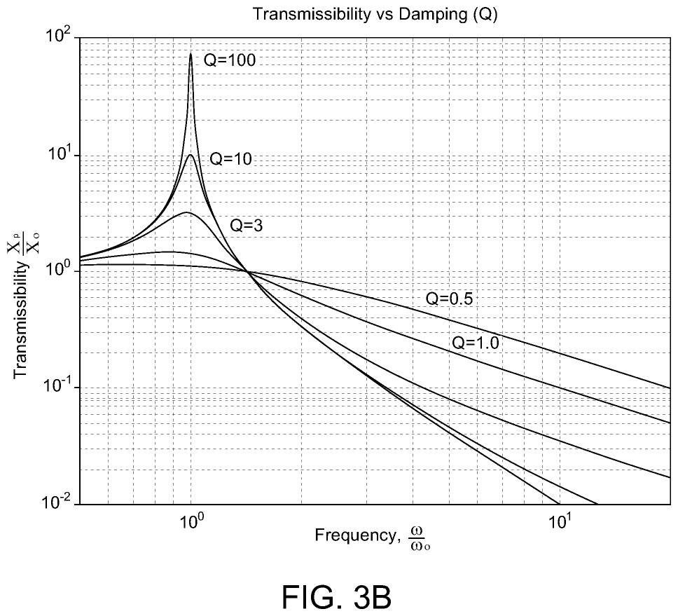

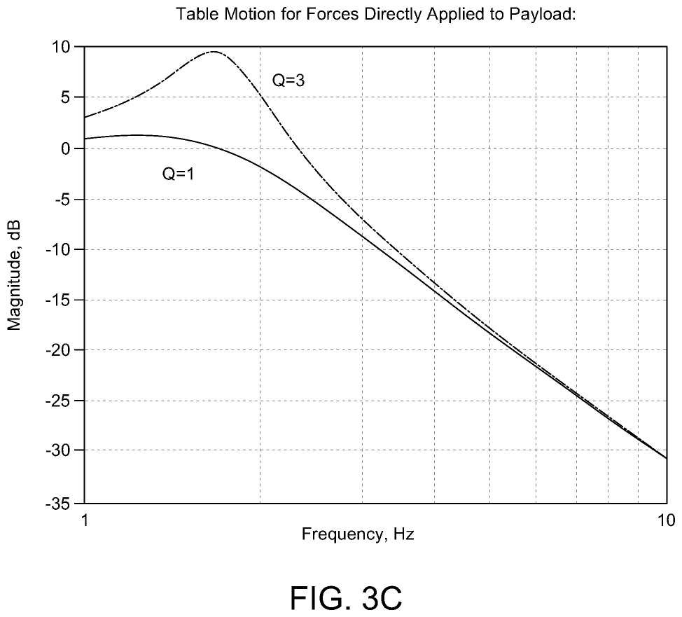

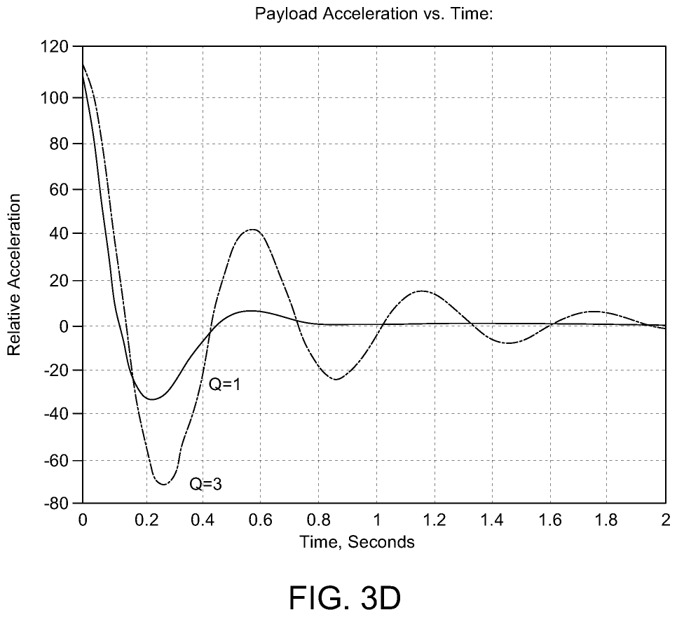

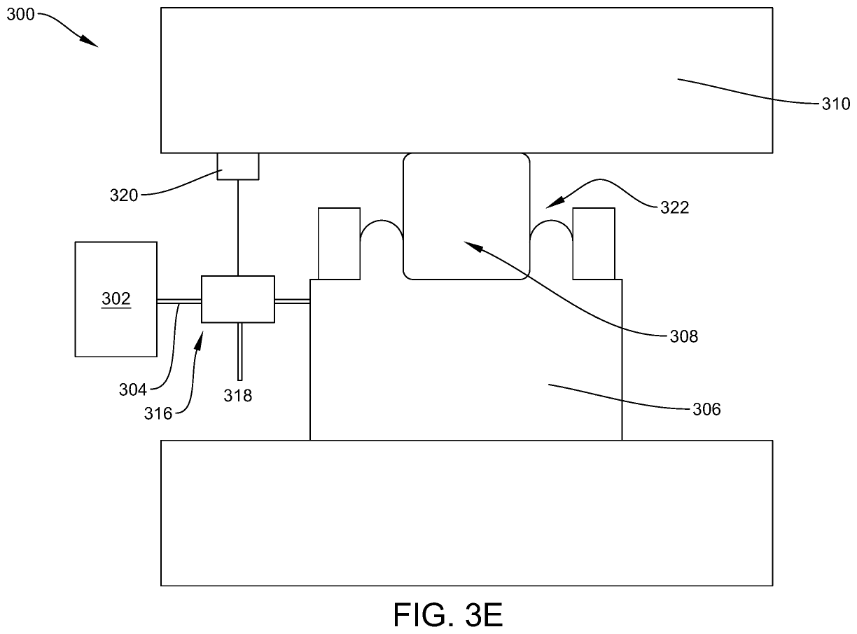

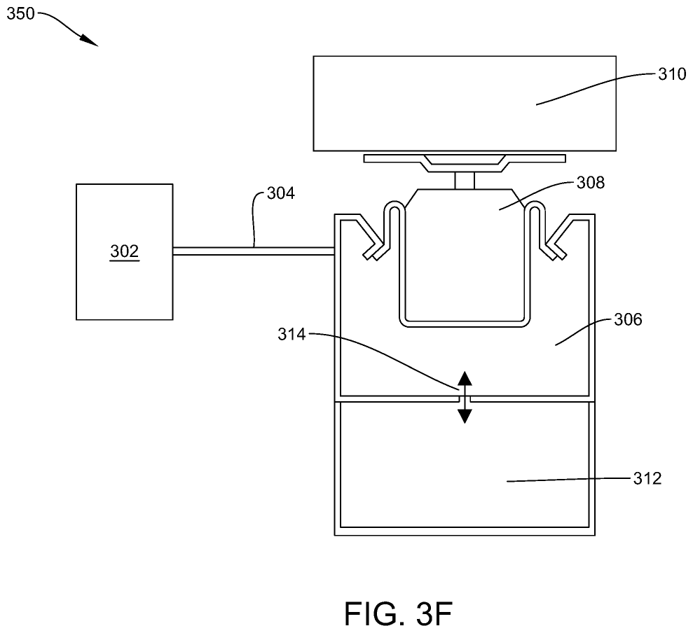

FIG. 3A illustrates an idealized, one degree-of-freedom (DOF) isolator based on a simple harmonic oscillator. As will be described in more detail below, a pneumatic isolation system can be modeled based on a harmonic oscillator. An idealized, one-DOF isolator based on a harmonic oscillator consists of three components: an isolated mass (M), a spring having a spring constant (k), and a damper having a damping coefficient (c). The isolated mass (M) represents the payload being isolated (e.g., a tabletop and an opto-fluidic instrument positioned thereon) and is shown as a single block mass with no internal resonances. FN represents a noise force directly applied to the isolated mass. A spring supports the payload and produces a force on the payload given by:

$$Force = k \times ( {X}_{e} - {X}_{p} )$$

where Xₑ represents ground motion (dynamic position of the Earth), Xₚ represents payload motion (dynamic position of the payload), c represents damping coefficient, k represents spring constant, and M represents mass of the isolated payload. The third component is the damper having the damping coefficient (c), which is represented schematically as a dashpot. A damper is configured to absorb kinetic energy from the isolated mass (M) by transforming the kinetic energy into heat, eventually bringing the system to rest. The damper performs this by producing a force on the payload proportional and opposite to its velocity relative to a reference (e.g., Earth):

$$Force = c \times ( \frac{{dX}_{e}}{dt} - \frac{{dX}_{p}}{dt} )$$

The presence of Xₑ in both of these equations shows that vibration of the Earth is transmitted as a force to the payload by both the spring (k) and the damper (c). Rather than use the parameters (M), (k), and (c) to describe a system, a new set of parameters are determined which relate more easily to the observable properties of the mass-spring system. The natural resonant frequency, ω₀, is given by:

$${ω}_{0} = \sqrt{\frac{k}{M}}$$

Natural resonant frequency defines the frequency of free oscillation for the system in the absence of any damping (c=0) in radians/second. The frequency in cycles per second, or Hertz (Hz), is the angular frequency divided by 2π. One of two common parameters are used to describe the damping in a system: the quality factor Q or the damping ratio ξ, defined by:

$$Q = \frac{{ω}_{0} M}{c}$$

$$ζ = \frac{c}{2 M {ω}_{0}}$$

It can be shown that the transmissibility (from the base/Earth to the payload) for this idealized system is:

$$T = \frac{{X}_{p}}{{X}_{e}} = \sqrt{\frac{1 + {( \frac{ω}{Q {ω}_{0}} )}^{2}}{{( 1 - \frac{{ω}^{2}}{{ω}_{0}^{2}} )}^{2} + {( \frac{ω}{Q {ω}_{0}} )}^{2}}}$$

FIG. 3B illustrates a transmissibility curve of a harmonic oscillator. In particular, FIG. 3B plots the transmissibility of the system versus the frequency ratio ω/ω0 for several values of the quality factor Q. The values of Q plotted range from 0.5 to 100. Q=0.5 is a special case called critical damping and is the level of damping at which the system will not overshoot the equilibrium position when displaced and released. The damping ratio ζ is the fraction of the system's damping to critical damping. In various embodiments, Q is used instead of ζ because T≃Q at ω=ω0, for Q above about 2. In various embodiments, there are several features which characterize the transmissibility shown in FIG. 3B. In the region ω<<ω₀, the transmissibility for the system is ≃1. In this case, the payload tracks the motion of the ground (e.g., Earth) and no isolation is provided. In the region where ω≃ω₀, the transmissibility is greater than one, and the spring/damper isolator amplify the ground motion by a factor roughly equal to Q. As ω becomes greater than ω₀, the transmissibility becomes proportional to (ω₀/ω)². In various embodiments, this is the region where the isolator is providing a benefit. In the region ω>>ω₀, the best isolation is provided by the system with the smallest level of damping. In various embodiments, the level of isolation is compromised as the damping increases. In various embodiments, there may be a tradeoff between providing isolation in the region ω>>>ω0 versus ω≃ω₀.

The amplitude of motion transmitted to the payload by forces directly applied to it has units of displacement per unit force and is defined by:

$$\frac{{X}_{p}}{{F}_{p}} = \frac{Q}{{M [ {{Q}^{2} ( {ω}_{0}^{2} - {ω}^{2} )}^{2} + {( ω {ω}_{0} )}^{2} ]}^{1 / 2}}$$

FIG. 3C plots this function versus frequency. Unlike FIG. 3B, decreasing the Q reduces the response of the payload at all frequencies, including the region ω>>ω₀. FIG. 3D shows the time-domain response of the payload corresponding to the curves shown in FIG. 3C. FIG. 3D also illustrates the decay of the system once a disturbance is applied to the system. The envelope for the decay is expressed as exp(−ω₀t/2Q).

FIG. 3E illustrates an exemplary piston air isolator 300. As shown in FIG. 3E, a source of pressurized gas 302 is provided. The source of pressurized gas 302 is connected to a first chamber 306 of the piston air isolator 300 via a tube 304 (e.g., hose). For example, the tube may be a high-pressure gas hose having a plurality of layers, including, but not limited to, a PFA or ETFE inner tubing, a aramid fiber (e.g., PPTA) braid, an interlayer PTFE tape, an outer stainless steel braid, and an optional thermoplastic polyester elastomer jacket. As another example, the tube 304 may be a standard polymeric tube rated for the appropriate pressure required by the piston air isolator 300. In various embodiments, the first chamber 306 configured to be an air spring (having an effective spring constant k) and a piston 308 positioned on a diaphragm 322 that is configured to expand and contract based on the pressure inside the first chamber 306. In various embodiments, the diaphragm 322 is made of an elastically deformable material (e.g., a reinforced rolling rubber diaphragm). In various embodiments, as the piston 308 moves down, gas (e.g., air) within the first chamber 306 compresses and thus resists the motion (similar to a spring compressing). In this way, the piston air isolator 300, and more specifically the first chamber 306, has an effective spring constant k. A payload 310 (e.g., a tabletop with or without an instrument disposed thereon) is positioned on the piston 308 and, thus, is isolated from external vibrations. In various embodiments, the diaphragm 322 forms a seal between the first chamber 306 and the piston.

In various embodiments, a valve 316 (e.g., a height control valve) is fluidically connected to the tube 304 between the source of pressurized gas 302 and the first chamber 306. In various embodiments the valve 316 is a height control valve and is connected directly to the payload 310 at a lever 320 via a rod. When the payload 310 moves up or down, the lever 320 causes the valve 316 to adjust the flow rate of gas entering the first chamber 306, thereby raising or lowering the piston 308 (which raises or lowers the payload 310). In various embodiments, the valve 316 includes a vent 318 configured to release gas from the first chamber 306, e.g., to lower the piston 308. In various embodiments, the pressure in the piston air isolator 300 is controlled by the height control valve 316 which senses the height of the payload 310 and inflates the first chamber 306 until the payload 310 is “floating.” In various embodiments, pneumatic vibration isolators (e.g., piston air isolator 300) provide many advantages. For example, it can be shown that the resonant frequency of the payload on a piston air isolator 300 is approximately:

$${ω}_{0} \approx \sqrt{\frac{nAg}{V}}$$

where g is acceleration of gravity (386 in/s² or 9.8 m/s²) and n is the gas constant for air and equal to 1.4. Unlike coil springs, this resonant frequency is approximately independent of the mass of the payload 310, and the height control valve 320 brings the payload 310 back to the same operating height. In various embodiments, gas springs are also extremely lightweight, eliminating any internal spring resonances which can degrade the performance of the isolator. This equation assumes the pressure in the isolator is high compared to atmospheric pressure. In various embodiments, isolators having a lighter payload may exhibit a slightly higher resonant frequency. In various embodiments, the pneumatic vibration isolator has an effective spring constant that is frequency dependent. In various embodiments, the pneumatic vibration isolator has an effective damping coefficient that varies based on displacement of the piston (e.g., strong damping for large displacements and low damping for small displacements). In various embodiments, the effective spring constant k is pressure-dependent (e.g., higher spring constant for higher pressure). In various embodiments, the effective damping coefficient is pressure-dependent (e.g., higher damping for higher pressure). In various embodiments, the vertical spring constant is different (e.g., larger or smaller) from the horizontal spring constant. In various embodiments, the vertical damping coefficient is different (e.g., larger or smaller) from the horizontal damping coefficient.

The load capacity of an isolator is set by the area of the piston A and the maximum pressure the diaphragm 322 can tolerate and is simply the product of these two numbers. In various embodiments, the piston air isolator 300 is rated at about 80 psi. In various embodiments, the piston air isolator 300 is rated at about 50 psi to about 100 psi. Using 80 psi as an example, a 4-inch piston would be capable of supporting a 1,000-lb load.

FIG. 3F illustrates an exemplary piston air isolator 350 that is similar to the piston air isolator 300 shown in FIG. 3E. However, the piston air isolator 350 includes a second chamber 312 configured for dampening oscillations applied to the first chamber 306 (the “air spring”). As shown in FIG. 3F, in various embodiments, the piston air isolator 350 includes two air chambers, a first chamber 306 configured to be an air spring (having an effective spring constant k) and a second chamber 312 configured to be a damper (having a damping coefficient c). In various embodiments, the first chamber 306 and the second chamber 312 are connected by an orifice 314. In various embodiments, the orifice 314 includes a valve. In various embodiments, the orifice 314 includes a capillary tube. In various embodiments, as the piston moves up and down, air is forced to move through this orifice 314, producing a damping force on the payload 310. In various embodiments, this type of damping is variable-strong for large displacements of the piston 308 and weaker for small displacements of the piston 308. In various embodiments, this variable damping allows for fast settling of the payload 310, without compromising small amplitude vibration isolation performance. In various embodiments, damping of this type usually produces a Q≈3 for displacements on the order of a few millimeters. In various embodiments, the damping provided by an orifice 314 is limited by several factors. In various embodiments, a viscous fluid may be used to provide damping. An exemplary isolator using a multi-axis viscous fluid is described in U.S. Pat. No. 5,918,862, which is hereby incorporated by reference herein in its entirety. These dual-chamber isolators can extend the damping to near critical levels for those applications which require critical damped payloads.

In various embodiments, three or more isolators (e.g., 4, 6, 8) are required to support a payload (minimum of three isolators to control for roll, pitch, yaw and provide a level plane). In various embodiments, a system can include up to three valves, and thus, two legs in a 4-post system must be connected as a master/slave combination. In various embodiments, for small rigid payloads, best performance can be achieved when positioning the isolators as close to the corners of the payload as possible. In various embodiments, this positioning improves the tilt stability of the system, reduces the motions of the payload caused by onboard disturbances, and improves both the leveling and settling times for the system. Leveling time is the time for the valving system to bring the payload to the correct height and tilt. Settling time is the time for a payload to come to rest after an impulse disturbance. In various embodiments, for extended surfaces, such as large optical tables, isolators can be positioned under the surface's nodal lines. In various embodiments, this minimizes the influence of forces transmitted to the table through the isolators. In various embodiments, position the payload's center-of-mass in the same plane as the isolator's effective support points results in the best performance, improving stability of the system and decoupling the horizontal and tilt motions of the payload.

In various embodiments, when each piston air isolator 300, 350 is fluidically connected to a source of pressurized gas 302, pressurized gas flows forward to the first chamber 306, but may also flow back towards the source of pressurized gas 302 if the payload 310 is disturbed (e.g., if a vibration causes a force on the payload 310 thereby displacing the payload 310). Backward flow of gas (or resistance causing a slower forward flow rate) may negatively affect the settling time of the payload (e.g., increase the settling time). In particular, the backward flow of gas (or resistance causing a slower forward flow rate) may delay settling of the payload after the payload receives a force (e.g., a vibration) that causes displacement of the payload. Moreover, the backward flow of gas (or resistance causing a slower forward flow rate) may create pressure oscillations in the gas line that negatively affect the settling time of the payload. One method to improve (e.g., shorten) the settling time of the payload (and improve the performance of the pneumatic vibration isolation system) is to increase the effective spring constant of the air spring and/or increase the damping coefficient of the air damper. As will be discussed in more detail below, a one-way restrictor valve fluidically connected between the source of pressurized gas and the pneumatic vibration isolation system increases the effective spring constant of the air spring and/or reduces pressure oscillations in the gas line, which improves vibration isolation performance (e.g., shortens the settling time of the payload).

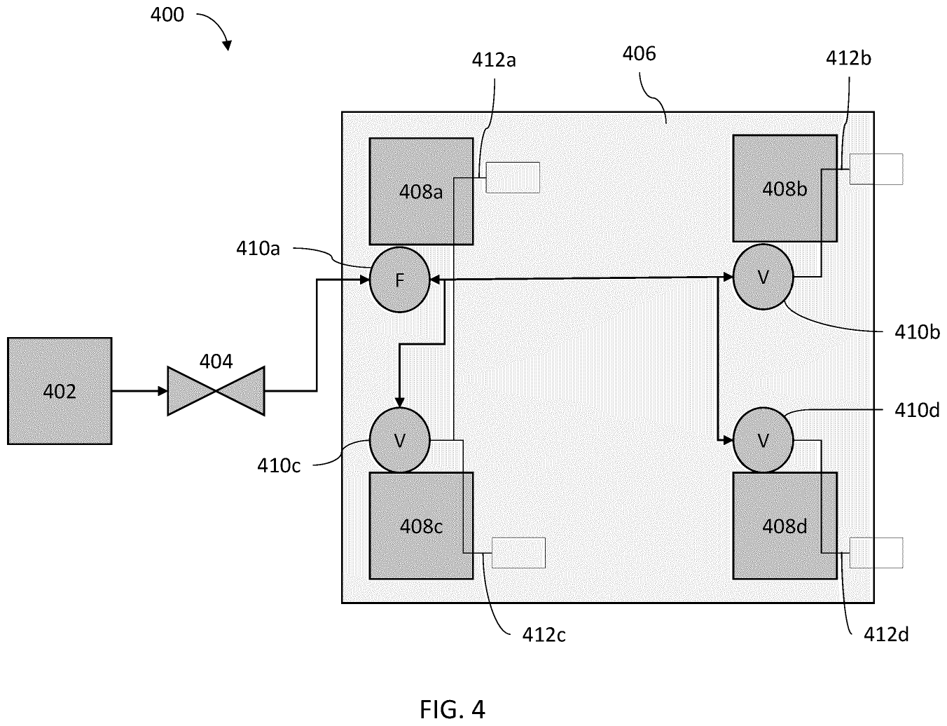

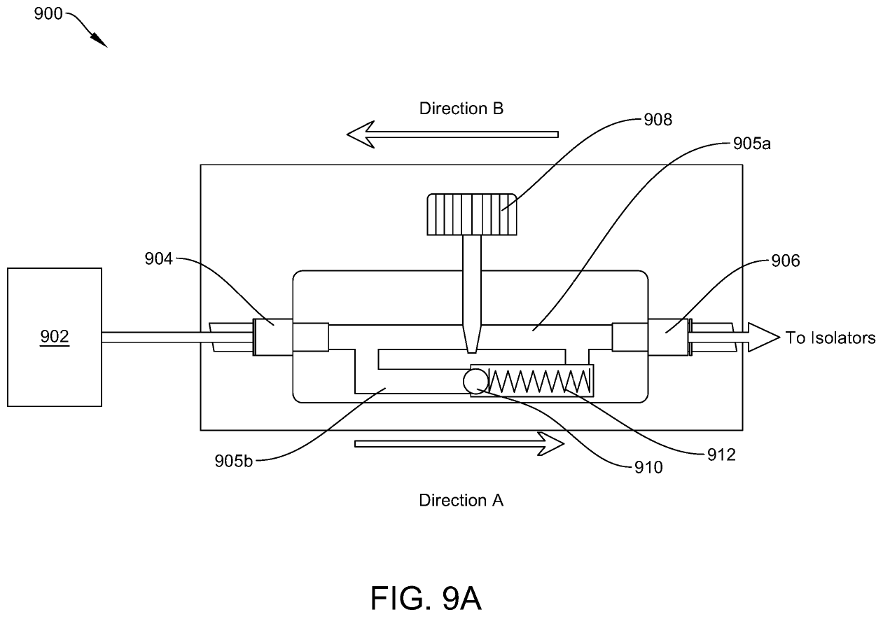

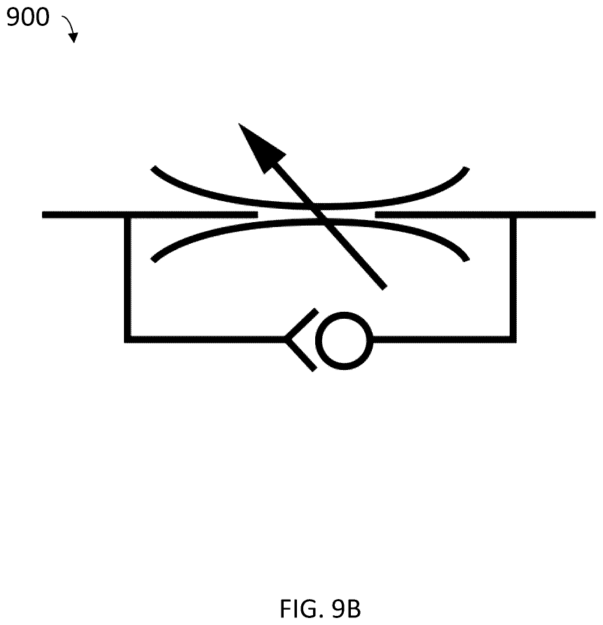

FIG. 4 illustrates a block diagram of a pneumatic vibration isolation system 400. As shown in FIG. 4, the pneumatic vibration isolation system 400 includes a source of pressurized gas 402 (e.g., source of pressurized air). In various embodiments, the source of pressurized gas 402 supplies pressurized atmospheric air, for example, a standard compressed air supply in a research laboratory. In various embodiments, the source of pressurized gas 402 supplies any suitable pressurized gas, such as nitrogen or carbon dioxide. The source of pressurized gas 402 is fluidically coupled to a one-way restrictor valve 404 configured to restrict flow of the pressurized gas in one or both directions. An example of a one-way restrictor valve is shown in FIGS. 9A-9B. In various embodiments, the one-way restrictor valve 404 fully restricts (e.g., does not allow any) flow in one direction, for example, flow back towards the source of pressurized gas 402. In various embodiments, the one-way restrictor valve 404 partially restricts flow in one direction, for example, flow back towards the source of pressurized gas. In various embodiments, the one-way restrictor valve 404 includes a throttle check valve. In various embodiments, the one-way restrictor valve 404 includes piloted non-return valve. In various embodiments, the one-way restrictor valve 404 includes a functional combination of a throttle check valve and a piloted non-return valve. In various embodiments, the one-way restrictor valve 404 includes a one-way check valve configured to open to allow flow in one direction and close when flow of gas stops or reverses. In various embodiments, the one-way restrictor valve 404 includes a flow control valve (e.g., with or without a flow indicator). In various embodiments, the flow control valve is pressure actuated (controls flow independently of pressure). In various embodiments, the one-way restrictor valve 404 is a one-way control valve configured to restrict flow in one direction, for example, the direction towards the vibration isolation system and, by restricting flow in the single direction, the valve also restricts some flow in the reverse direction. In various embodiments, the restriction of flow in the reverse direction may be proportional to the restriction in the metered direction (e.g., towards the vibration isolation system). In various embodiments, restricting flow in the reverse direction to a suitable extent (e.g., via a one-way restrictor valve) reduces or eliminates pressure oscillations that occur when the vibration isolation system receives a disturbance (e.g., bump or vibration). In various embodiments, by reducing or eliminating the pressure oscillations that occur in the fluid lines (that would occur when no flow restrictors are between the source of pressurized gas and the vibration isolation system), a spring constant of the air spring (e.g., the first chamber in a dual chamber vibration isolation module) and/or a damping coefficient of an air damper (e.g., the second, lower chamber in the dual chamber vibration isolation module) are increased, thereby decreasing settling times of the isolated payload.

FIG. 9A illustrates an exemplary single-directional or one-way flow restrictor valve 900 that is a flow control valve (and may be used as one-way restrictor valve 404 fluidically connected between the source of pressurized gas and the pneumatic vibration isolation system). As shown in FIG. 9A, the one-way flow restrictor valve 900 is fluidically connected to a source of pressurized gas 902 at an inlet 904. Pressurized gas from the source of pressurized gas 902 travels through the inlet 904 and splits into a first path 905a having a restriction adjuster 908 configured to restrict the flow of the pressurized gas from 0% restricted to 100% (fully) restricted leading to an outlet 906, and a second path 905b having a smaller diameter segment and a larger diameter segment in which a ball 910 and spring 912 are arranged to seal the second path 905b with a predetermined force (which can be calculated by the spring constant times the displacement of the spring from a neutral spring position when the ball is sealingly contacting the smaller diameter segment of the second path 905b) also leading to the outlet 906. In various embodiments, the spring 912 that seals the smaller diameter segment is selected such that a predetermined pressure (force per unit area) of gas will overcome the spring force and allow flow of gas past the ball 910 and to the outlet 906. In various embodiments, the one-way restrictor valve 900 has a check valve therein allowing for approximately free flow of a gas (e.g., air) in one direction (Direction A) after the spring force is overcome and the ball is displaced to the right thereby allowing free flow of gas and controlled flow in the other direction (Direction B). In Direction A, gas (e.g., air) can flow freely past the ball, bypassing the restriction adjuster 908. In Direction B, gas (e.g., air) cannot flow freely past the ball, so it must flow past the restriction adjuster 908. In various embodiments, the restriction adjuster 908 is a threaded adjuster where unscrewing the adjuster (e.g., twisting counterclockwise) allows for more gas flow (in one or both directions) and tightening the adjuster (e.g., twisting clockwise) allows for less gas flow (in one or both directions). FIG. 9B illustrates a diagram of the one-way flow restrictor valve of FIG. 9A. In various embodiments, the one-way flow restrictor valve is combined with a check valve to 1) adjust the flow in one direction (e.g., the direction towards the vibration isolation system, Direction A) and 2) partially or fully block the air in the reverse direction (towards the source of pressurized gas, Direction B). In various embodiments, restricting the flow of gas in the reverse direction in greater percentages results in additional improved performance of the vibration isolation system (e.g., restricting the flow of pressurized gas in the reverse direction by 75-100% may provide additional system improvements over restricting a lesser percentage, such as less than 50% of the flow). In various embodiments, the one-way flow restrictor valve 900 is configured for receiving a fluid. In some embodiments, the fluid is a compressible fluid, e.g., a gas. In other embodiments, the fluid is an incompressible fluid, e.g., a liquid.

In various embodiments, the one-way restrictor valve 404, 900 restricts about 1% to about 100% of flow in one direction. In various embodiments, the one-way restrictor valve 404, 900 restricts about 5% to about 100% of flow in one direction. In various embodiments, the one-way restrictor valve 404, 900 restricts about 10% to about 100% of flow in one direction. In various embodiments, the one-way restrictor valve 404, 900 restricts about 15% to about 100% of flow in one direction. In various embodiments, the one-way restrictor valve 404, 900 restricts about 20% to about 100% of flow in one direction. In various embodiments, the one-way restrictor valve 404, 900 restricts about 25% to about 100% of flow in one direction. In various embodiments, the one-way restrictor valve 404, 900 restricts about 30% to about 100% of flow in one direction. In various embodiments, the one-way restrictor valve 404, 900 restricts about 35% to about 100% of flow in one direction. In various embodiments, the one-way restrictor valve 404, 900 restricts about 40% to about 100% of flow in one direction. In various embodiments, the one-way restrictor valve 404, 900 restricts about 45% to about 100% of flow in one direction. In various embodiments, the one-way restrictor valve 404, 900 restricts about 50% to about 100% of flow in one direction. In various embodiments, the one-way restrictor valve 404, 900 restricts about 55% to about 100% of flow in one direction. In various embodiments, the one-way restrictor valve 404, 900 restricts about 60% to about 100% of flow in one direction. In various embodiments, the one-way restrictor valve 404, 900 restricts about 65% to about 100% of flow in one direction. In various embodiments, the one-way restrictor valve 404, 900 restricts about 70% to about 100% of flow in one direction. In various embodiments, the one-way restrictor valve 404, 900 restricts about 75% to about 100% of flow in one direction. In various embodiments, the one-way restrictor valve 404, 900 restricts about 80% to about 100% of flow in one direction. In various embodiments, the one-way restrictor valve 404, 900 restricts about 85% to about 100% of flow in one direction. In various embodiments, the one-way restrictor valve 404, 900 restricts about 90% to about 100% of flow in one direction. In various embodiments, the one-way restrictor valve 404, 900 restricts more than 5% of flow in one direction. In various embodiments, the one-way restrictor valve 404, 900 restricts more than 10% of flow in one direction. In various embodiments, the one-way restrictor valve 404, 900 restricts more than 15% of flow in one direction. In various embodiments, the one-way restrictor valve 404, 900 restricts more than 20% of flow in one direction. In various embodiments, the one-way restrictor valve 404, 900 restricts more than 25% of flow in one direction. In various embodiments, the one-way restrictor valve 404, 900 restricts more than 30% of flow in one direction. In various embodiments, the one-way restrictor valve 404, 900 restricts more than 35% of flow in one direction. In various embodiments, the one-way restrictor valve 404, 900 restricts more than 40% of flow in one direction. In various embodiments, the one-way restrictor valve 404, 900 restricts more than 45% of flow in one direction. In various embodiments, the one-way restrictor valve 404, 900 restricts more than 50% of flow in one direction. In various embodiments, the one-way restrictor valve 404, 900 restricts more than 55% of flow in one direction. In various embodiments, the one-way restrictor valve 404, 900 restricts more than 60% of flow in one direction. In various embodiments, the one-way restrictor valve 404, 900 restricts more than 65% of flow in one direction. In various embodiments, the one-way restrictor valve 404, 900 restricts more than 70% of flow in one direction. In various embodiments, the one-way restrictor valve 404, 900 restricts more than 75% of flow in one direction. In various embodiments, the one-way restrictor valve 404, 900 restricts more than 80% of flow in one direction. In various embodiments, the one-way restrictor valve 404, 900 restricts more than 85% of flow in one direction. In various embodiments, the one-way restrictor valve 404, 900 restricts more than 90% of flow in one direction. In various embodiments, the one-way restrictor valve 404, 900 restricts more than 95% of flow in one direction.

In various embodiments, an analytical instrument (such as the opto-fluidic instrument 102) is positioned on the isolated tabletop 406 to thereby isolate the analytical instrument from external vibrations. Exemplary sources of external vibrations include vibrations caused by humans or animals walking and/or running, vibrations caused by mechanical devices (e.g., other laboratory instruments, building HVAC systems, etc.), vibrations caused by motorized vehicles or trains, vibrations caused by tectonic plates shifting within the Earth, among other sources. In various embodiments, the analytical instrument and the tabletop 406 are collectively called the “isolated payload” when vibration isolation is operative/functioning (e.g., when pressurized gas is flowing into each of the plurality of vibration isolation modules to thereby “float” the tabletop and the payload which thereby become the isolated payload). The isolated tabletop 406 is positioned on a plurality of pneumatic vibration isolation modules 408a, 408b, 408c, 408d (e.g., the piston air isolator of FIG. 3E) configured to damp any vibrations received from the ground. In various embodiments, the plurality of pneumatic vibration isolation modules 408a-408d are affixed to a rigid frame (not shown) that is in contact with the ground. In various embodiments, the rigid frame is a metal (e.g., steel) frame.

As shown in FIG. 4, the plurality of pneumatic vibration isolation modules 408a-408d further include at least one filter 410a and one or more valves 410b, 410c, 410d. When the tabletop oscillates (e.g., due to an impulse applied to the tabletop), servo valves located at each leg/isolator automatically feed or bleed air from each isolator. The changes in air pressure at the individual piston air isolators (due to the effects of the servo valve adjustments) cause oscillations at the pressure source, which may affect the ability of the tabletop to efficiently dampen vibrations. In various embodiments, eliminating these pressure variations at the pressure source may improve performance of the air isolation table.

In various embodiments, all rigid payloads use three height control valves. Because three points define a plane, using a greater number of valves would mechanically over-constrain the system and result in poor position stability and cause a continuous consumption of pressurized gas. FIG. 4 illustrates the typical plumbing for a 4-isolator system. In various embodiments, a pneumatic vibration isolation system 400 includes three valves 410b, 410c, 410d, a pressure regulator/filter 410a (optional), and outlets 412a, 412b, 412c, 412d (e.g., an orifice pigtail) on each isolator 408a-408d. In various embodiments, the outlets 412a-412d are configured to release gas from the one or more valves 410b-410d during damping of vibrations. In various embodiments, the pigtail is a short section of tubing with an orifice inserted inside. In various embodiments, a mechanical valving system is a type of servo, and these orifices limit the “gain” of the servo to prevent oscillation. In various embodiments, high center-of-gravity systems may require smaller orifices to prevent instabilities.

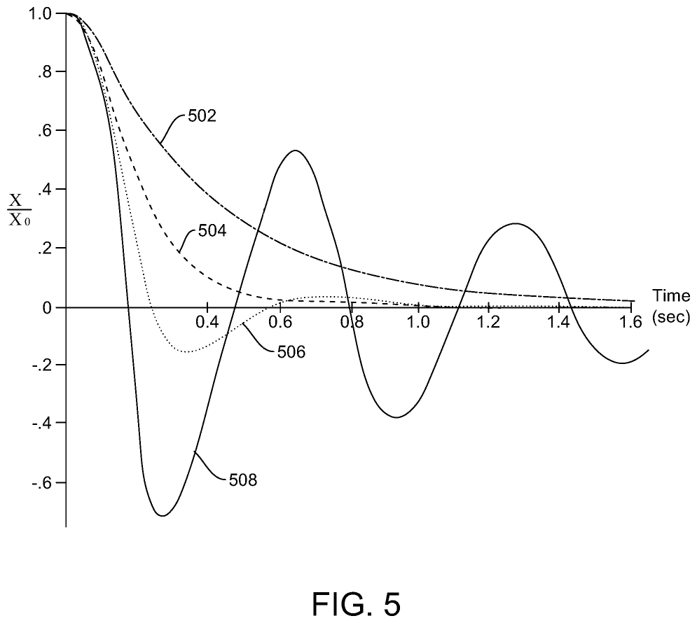

FIG. 5 illustrates a graph of damped and overdamped responses of an oscillator. As shown in FIG. 5, when a pneumatic vibration isolation system is disturbed, the amplitude of displacement will decrease over time due to damping. In various embodiments, damping is provided by one or more dampers. In various embodiments, an air damper is provided in a piston air isolator as a second chamber. In various embodiments, settling time of an isolated payload is the amount of time required for the isolated payload to receive a disturbance (e.g., an impulse force) until the magnitude of displacement is reduced below a predetermined threshold. Line 502 plots the impulse response of an overdamped system, line 504 plots the impulse response of a system with critical damping, line 506 plots the impulse response of a system with one-half critical damping, and line 508 plots the impulse response of a system with one tenth critical damping. For example, when a pneumatic vibration isolation system is configured with one-tenth of critical damping, the settling time for vibrations to have a magnitude below x/x₀=0.2 would be about 1.6 seconds. As one skilled in the art will appreciate, a critically damped system experiences minimal oscillatory behavior (e.g., the system does not experience any oscillations) after receiving a force displacing the payload from a resting position. Any system that is less than critically damped will experience some oscillatory behavior that settles to a neutral or resting position after some amount of time (settling time is longer for smaller amounts of damping, for example, settling time is longer for one-tenth critical damping compared to the settling time for one-half critical damping). Advantageously, the systems and methods of the present disclosure reduce the settling time of an isolated payload by increasing the effective spring constant (of the air spring) and/or increasing the damping coefficient (of the air damper or inherent damping effects associated with the isolator).

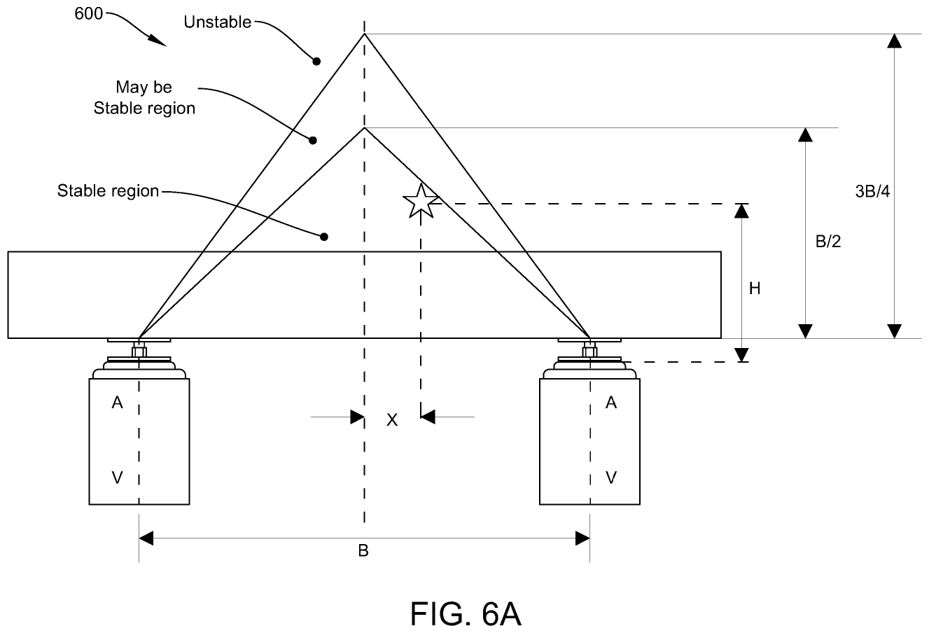

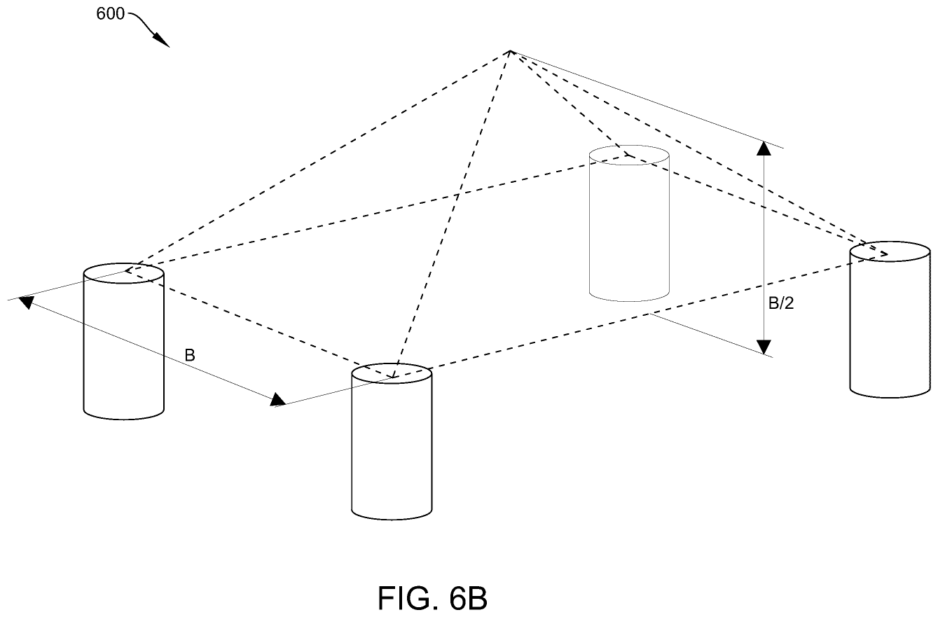

FIGS. 6A-6B illustrate zones of gravitational stability of an isolated payload supported on a tabletop. In particular, FIG. 6A illustrates a two-dimensional side profile of gravitational stability of a pneumatic vibration isolation system 600 and FIG. 6B illustrates the gravitational stability of the same pneumatic vibration isolation system 600, but through a perspective view. In various embodiments, payloads supported below the center of mass (COM) are inherently unstable. As the payload tilts, its center-of-mass moves horizontally in a way that wants to further increase the tilt. Countering this tilt is the stiffness of the pneumatic isolators, which provide a reaction force to restore the payload to level. In various embodiments, the balance of these two forces determines whether the system is gravitationally stable. FIGS. 6A-6B show a payload supported by pneumatic isolators. The width between the isolators' centers is B, the height of the payload's COM is H above the effective support point for the isolators, and the horizontal position of the COM from the centerline between the isolators is X. It can be shown that there is a region of stability given by the condition:

$$H < \frac{A n}{V} ( \frac{B}{2} - X ) ( \frac{B}{2} + X )$$

### Or, for X=0,

$$H < \frac{{AnB}^{2}}{4 V}$$

where n is the gas constant and is equal to 1.4, A is the piston area, and V is the pressurized volume. In various embodiments, B/2 is about 12 inches from a bottom surface of a chassis of the opto-fluidic instrument.

This relationship is shown in FIG. 6B which defines the stable and unstable regions for the COM location. The second equation shows that the stability improves with the square of the isolator separation. This demonstrates that it is not the aspect ratio H/W that determines the stability of a system and that the stable region is not a triangle (in 2D) or pyramid (in 3D), but rather most likely an inverted parabola.

The ratio A/V in the above equations represents the stiffness of the isolators. In various embodiments, isolators have a spring constant which is frequency dependent. At high frequencies, the orifice between the two chambers effectively restricts (e.g., blocks) air flow, and V may be considered the top air volume alone. In various embodiments, at the resonance of a system, the “effective” air volume is somewhere between the top and total (top plus bottom) volumes. In various embodiments, at low frequencies, the action of the height control valves gives the isolators an extremely high stiffness (corresponding to a very small V). In various embodiments, the action of the height control valves provides a force to move the payload back towards level. Because the above equation does not effectively model two chamber isolators, three regions are defined: stable, unstable, and borderline (may be stable), the first two being based on the “total” and “top only” air volumes, respectively. In various embodiments, the stability region may be different for the axes parallel and perpendicular to the master/slave isolator axis.

In various embodiments, the center of gravity is not stationary during operation of an opto-fluidic instrument. In various embodiments, during operation of the opto-fluidic instrument, the center of gravity can shift due to motion of one or more subsystems, such as a fluidics subsystem that obtains and dispenses, or extracts reagents from an open well flow cell. In various embodiments, an optical subsystem moves an objective lens or a sample during imaging to obtain z-stacks of the biological sample, which may cause the center of gravity to shift.

### Example of Vibration Isolation of an Optofluidic Instrument

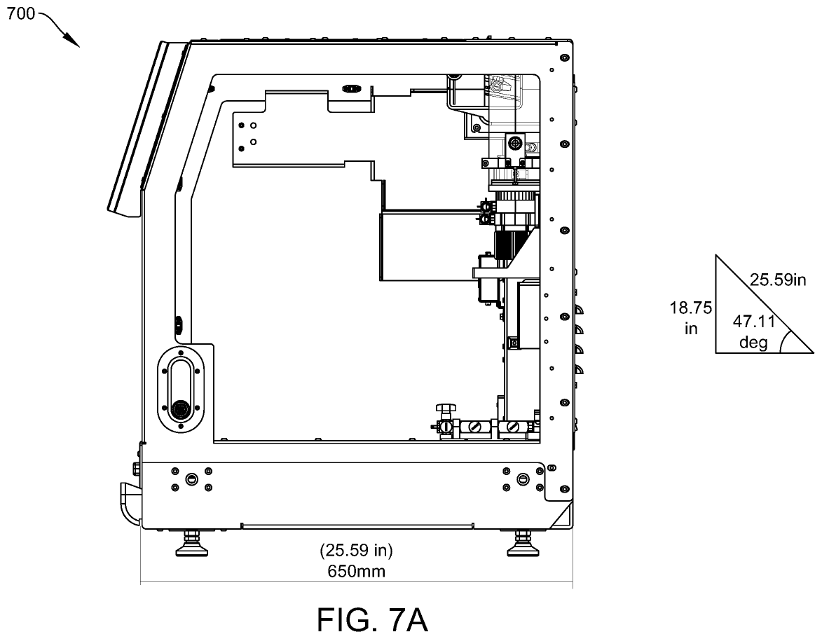

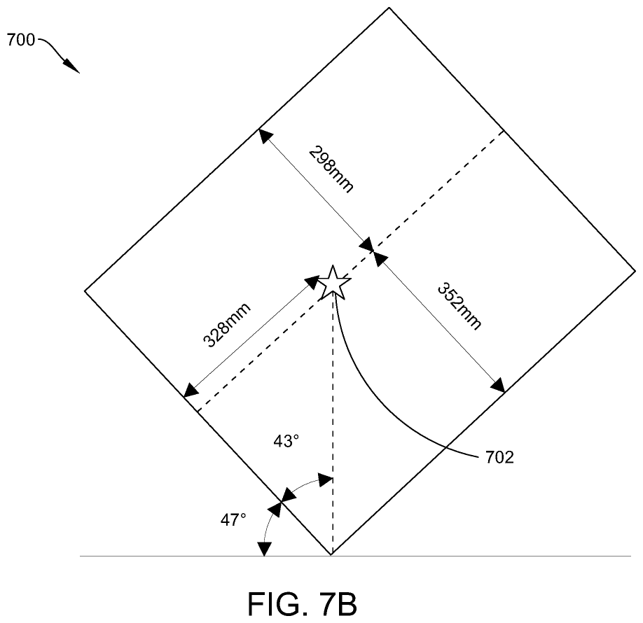

FIG. 7A illustrates a cross-section of an opto-fluidic instrument 700. In various embodiments, the opto-fluidic instrument 700 is similar to (e.g., identical to) opto-fluidic instrument 120. In various embodiments, the opto-fluidic instrument has a weight of greater than 500 lbs. In various embodiments, the opto-fluidic instrument has a weight of greater than 400 lbs. In various embodiments, the opto-fluidic instrument has a weight of greater than 300 lbs. In various embodiments, the opto-fluidic instrument has a weight of less than 1000 lbs. In various embodiments, the opto-fluidic instrument has a weight of about 400 lbs to about 1000 lbs. In various embodiments, the opto-fluidic instrument has a weight of about 400 lbs to about 900 lbs. In various embodiments, the opto-fluidic instrument has a weight of about 400 lbs to about 800 lbs. In various embodiments, the opto-fluidic instrument has a weight of about 400 lbs to about 700 lbs. In various embodiments, the opto-fluidic instrument has a weight of about 400 lbs to about 600 lbs. In various embodiments, the opto-fluidic instrument has a weight of about 400 lbs to about 500 lbs. In various embodiments, the opto-fluidic instrument has a weight of about 500 lbs to about 1000 lbs. In various embodiments, the opto-fluidic instrument has a weight of about 500 lbs to about 900 lbs. In various embodiments, the opto-fluidic instrument has a weight of about 500 lbs to about 800 lbs. In various embodiments, the opto-fluidic instrument has a weight of about 500 lbs to about 700 lbs. In various embodiments, the opto-fluidic instrument has a weight of about 500 lbs to about 600 lbs. In various embodiments, the opto-fluidic instrument has a weight of about 550 lbs.

Because the opto-fluidic instrument 700 may have a non-uniform weight distribution (due to, for example, the arrangement of internal subsystems and components), determining the center of gravity of the opto-fluidic instrument 700 may be non-trivial. FIG. 7B illustrates a tilt test to determine a center of gravity 702 of the opto-fluidic instrument 700 shown in FIG. 7A. As shown in FIG. 7B, the center of gravity 702 is approximately 298 mm from the front of the chassis, 626 mm from the left feet of the opto-fluidic instrument 700, 711.5 mm from the left side of the chassis, and 328 mm from the bottom surface of the opto-fluidic instrument 700.

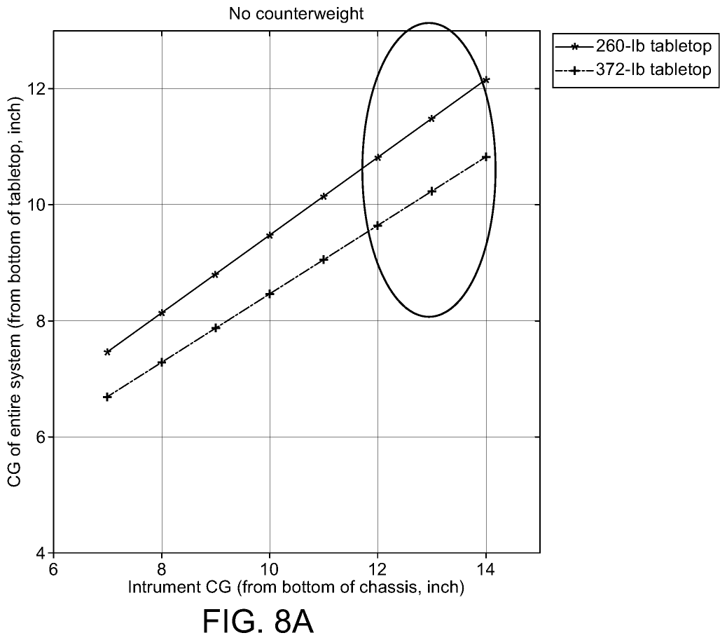

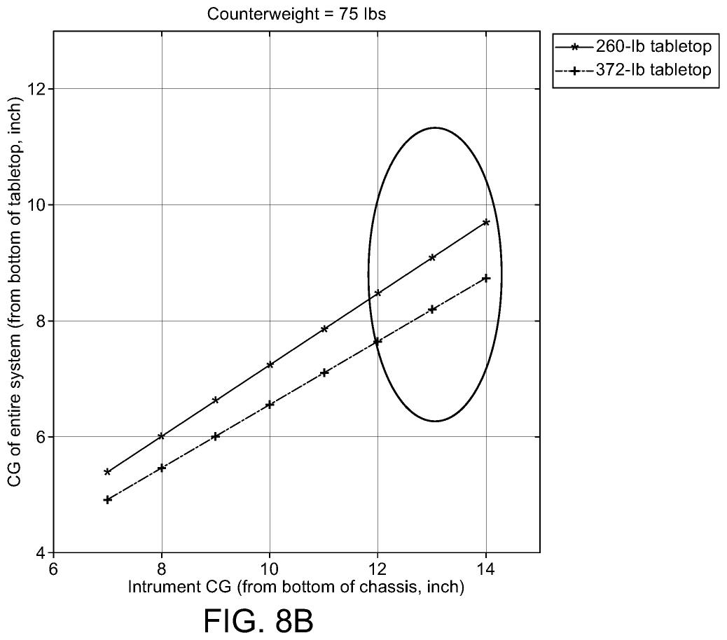

FIG. 8A illustrates a graph of the center of gravity of an opto-fluidic instrument supported on an air isolation tabletop without a counterweight attached to the tabletop. In various embodiments, a counterweight is affixed to a bottom of the tabletop to further lower a center of gravity of the isolated payload (combined tabletop and instrument). FIG. 8B illustrates a graph of the center of gravity of an opto-fluidic instrument supported on an air isolation tabletop with a counterweight attached to the bottom of the tabletop. As shown in FIG. 8B, adding a counterweight of about 75 lbs lowers the center of gravity of the isolated payload by about 2 inches.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system comprising:
a payload;
a source of pressurized gas;
a plurality of pneumatic vibration damping modules coupled to the payload, wherein each pneumatic vibration damping module of the plurality of pneumatic vibration damping modules is fluidically coupled to the source of pressurized gas; and
a one-way restrictor valve fluidically coupled between the source of pressurized gas and the plurality of vibration damping modules.

2. The system of claim 1, further comprising a tube fluidically coupling the source of pressurized gas to the plurality of pneumatic vibration dampening modules.

3. The system of claim 1, wherein at least two pneumatic vibration damping modules of the plurality of pneumatic vibration damping modules are fluidically coupled in parallel to the source of pressurized gas.

4. The system of claim 1, wherein all pneumatic vibration damping modules of the plurality of pneumatic vibration damping modules is fluidically coupled in parallel to the source of pressurized gas.

5. The system of claim 1, wherein the source of pressurized gas comprises air.

6. The system of claim 1, wherein the one-way restrictor valve is configured to allow pressurized gas to flow towards the plurality of vibration damping modules.

7. The system of claim 1, wherein the payload comprises a substantially flat top surface.

8. The system of claim 1, wherein each pneumatic vibration damping modules of the plurality of pneumatic vibration damping modules comprises a piston disposed on a first chamber.

9. The system of claim 8, further comprising a second chamber adjacent to the first chamber, wherein the first chamber and second chamber are fluidically coupled via an orifice.

10. The system of claim 9, wherein the orifice comprises a valve.

11. The system of claim 9, wherein the orifice comprises a capillary tube.

12. The system of claim 1, wherein the payload comprises a tabletop and an optofluidic instrument positioned on the tabletop.

13. The system of claim 1, wherein the one-way restrictor valve is configured to restrict flow of pressurized gas towards the source of pressurized gas.

14. The system of claim 1, wherein the one-way restrictor valve is configured to increase an effective stiffness of the plurality of pneumatic vibration damping modules.

15. The system of claim 1, wherein the one-way restrictor valve is configured to increase an effective damping of the plurality of pneumatic vibration damping modules.

16. The system of claim 1, wherein the one-way restrictor valve is configured to reduce pressure oscillations in the system after an external force is applied to the payload.

17. An assembly comprising:
a plurality of pneumatic vibration damping modules, each pneumatic vibration damping module of the plurality of pneumatic vibration damping modules configured to receive a pressurized gas;
a one-way restrictor valve; and
a tube fluidically coupling the one-way restrictor valve to the plurality of pneumatic vibration damping modules.

18-26. (canceled)

27. The assembly of claim 17, wherein the one-way restrictor valve is configured to restrict flow of pressurized gas towards the source of pressurized gas.

28. The assembly of claim 17, wherein the one-way restrictor valve is configured to increase an effective stiffness of the plurality of pneumatic vibration damping modules.

29-30. (canceled)

31. A method of providing vibration isolation to a payload, the method comprising:
providing the system of claim 1; and
providing, from the source of pressurized gas, a flow of pressurized gas through the one-way restrictor valve and to the plurality of pneumatic vibration damping modules thereby isolating the payload from vibrations.

32-33. (canceled)
